(19) United States
(12) Patent Application Publication
(10) Pub. No.: US 2012/0169017 A1
(43) Pub. Date: Jul. 5, 2012

(54) COLLET CHUCK

(76) Inventor: Hans-Dieter Mack, Sontheim (DE)

(21) Appl. No.: 13/376,960

(22) PCT Filed: Sep. 6, 2010
(86) PCT No.: PCT/DE10/75084

§ 371 Date: Dec. 20, 2011

(30) Foreign Application Priority Data
Sep. 18, 2009 (DE) 102009044049.6

(51) Int. Cl. B23B 31/20

(52) U.S. Cl. 279/52

(57) ABSTRACT

The invention relates to a collet chuck (1), comprising a chuck body (3) that is or can be connected in a rotationally fixed manner to a drive spindle (2), a collet (4), and a conical sleeve (5) associated with the chuck body (3). The conical sleeve (5) is arranged on the chuck body (3) in such a way that the conical sleeve cannot slide axially, and a threaded connection (6) is effective between the chuck body (3) and the collet (4).

The invention relates to a collet chuck having a chuck body that is or can be rotationally fixed to a drive spindle, having a collet and a frustoconically tapered sleeve attached to the chuck body.

A collet chuck of this type is known from EP 2 008 748 in which the collet is gripped in the tapered sleeve that in turn is surrounded in the chuck body by a clamping nut screwed onto an external screwthread on the chuck body, so that a first clamping can take place by tightening the clamping nut that can be rotated relative to the collet. Further clamping then takes place in that the tapered sleeve is displaced axially by a hydraulic clamping system that is formed in the chuck body. This collet chuck has a complex structure with many parts required for hydraulic adjustment, so that as a result the manufacture and assembly turns out to be relatively expensive.

The object of the invention is to provide a collet chuck of the type described above such that a sufficient clamping force is always available at low cost.

According to the invention, this object is attained by a collet chuck of the type described above in that the tapered sleeve is axially fixed on the chuck body and a threaded connection is operative between the chuck body and the collet.

The inventor has discovered that to securely clamp a workpiece or a tool such as, for example, a rotary cutter, in particular a router, it is sufficient to generate a sufficient initial clamping force when a threaded connection between the chuck body and the collet is operative, as in the seat of the collet chuck when it is driven to rotate by the drive spindle, braking moments act on the tool due to the workpiece being machined, which represent a torque acting upon the collet to rotate the collet. As a result of the rotation of the collet in the direction counter to the rotational direction of the drive spindle, the collet is adjusted with respect to the tapered sleeve that is axially fixed on the chuck body, so that, as a result, a self-tightening effect is created that ensures the required clamping force when the collet chuck is in operation.

Within the scope of a preferred embodiment of the invention the tapered sleeve has a frustoconical inner surface and surrounds the collet, is rotatably mounted on the chuck body, which means that, when the collet is rotated, the tapered sleeve is also rotationally entrained by friction and the sleeve does not impair the self-tightening effect as a result of friction acting via the chuck body.

As a result, in particular the possibility results that the tapered sleeve is rotationally fixed to the collet, so that between the collet and the tapered sleeve relative axial movement required for the self-tightening effect takes place.

It is particularly preferred within the scope of the invention when a threaded adapter is formed in the chuck body into which a screwthread of a collar of the collet is screwed, as this way the threaded connection between the directly affected components, namely the chuck body and the collet, can be designed elegantly with a small size ratio. However, alternatively, the possibility also exists that the chuck body is screwed into a body adapter of the collet with an external screwthread, in which case it is particularly advantageous when the chuck body is unitary with the drive spindle, as in turn, a very compact structure is achieved.

Within the scope of the invention, in general, there also exists the possibility that the tapered sleeve is unitarily formed with the chuck body and is received by the collet, i.e. the collet is used like an expanding mandrel in which the clamping segments of the collet are not effective radially inward, but radially outward to achieve the desired clamping of the workpiece or tool having a bore.

Since because of the self-tightening effect relatively large clamping forces can also be achieved, it is advantageous that at least one wrench flat is formed on the tapered sleeve in order to thus be able to always ensure opening of the collet chuck with the help of a tool.

A secure connection of the tapered sleeve to the chuck body can be achieved by bracing the axially rearward end of the tapered sleeve with a locking element on the chuck body, preferably gripped by a coupling nut located at the chuck body.

A further, particularly preferred embodiment of the invention is characterized in that the collet is rotationally and axially fixed to a clamping nut that engages with a collet thread formed on an outer surface of the chuck body for the threaded connection. In this design, the threaded connection between the chuck body and the collet uses a further part, namely the clamping nut that is rotationally and axially fixed to the collet, so that by means of an external screwthread of the chuck body, the required movement of the collet can be brought about. This way, the collet is particularly easily accessible for the user and can be easily grasped by the user, for which advantageously, the surface of the collet has a formation that increases friction. In addition, formations can also be provided on the collet, advantageously wrench flats or bores for an auxiliary tool that can be easily attached. The axial fixing of the clamping nut to the collet is achieved by coupling the clamping nut via at least one, preferably with two diametrically opposite pins to the collet.

The tapered sleeve is fixed axially opposite to the chuck body, and preferably the tapered sleeve is braced at its rear and/or the front by an axial-thrust bearing against the chuck body, and is secured by a snap ring. Bracing via an axial-thrust bearing directed axially toward the rear ensures that sufficiently large clamping forces are achieved, even if the collet transmits forces acting toward the rear onto the chuck body via the tapered sleeve during the clamping process.

To achieve a required clamping force it is sufficient when forces acting axially rearward due to the clamping nut are exerted on the collet and thus the collet is shifted axially backward with relative the tapered sleeve. It is desirable, however, that when opening the collet chuck the collet is also again axially forwardly shifted relative to the tapered sleeve without overly stressing the rotational coupling between the collet and the clamping nut. It is therefore provided that the clamping nut has a first sleeve section that carries the thread of the threaded connection and a second sleeve section with a smaller interior diameter with a coupling ridge formed on the inner surface that engages with an annular groove of the collet, so that as a result, when adjusting the clamping nut, axial movement of the collet with respect to the tapered sleeve is also ensured.

In collet chucks it is known that rubber ribs are located between the clamping segments of the collet, which, however, act against attaining a high clamping force. Within the scope of the invention it is therefore provided that elastomeric ribs are located between the clamping segments of the collet, limited to the axial front section of the clamping segments. These elastomeric ribs form a gasket of the collet chuck in the direction of the workpiece that is to be machined and are additionally sufficient to achieve uniform application of a force of the clamping segments and provide centering.

In the following, the invention will be explained in further detail with the reference to the illustrated embodiments shown in the drawing. Therein:

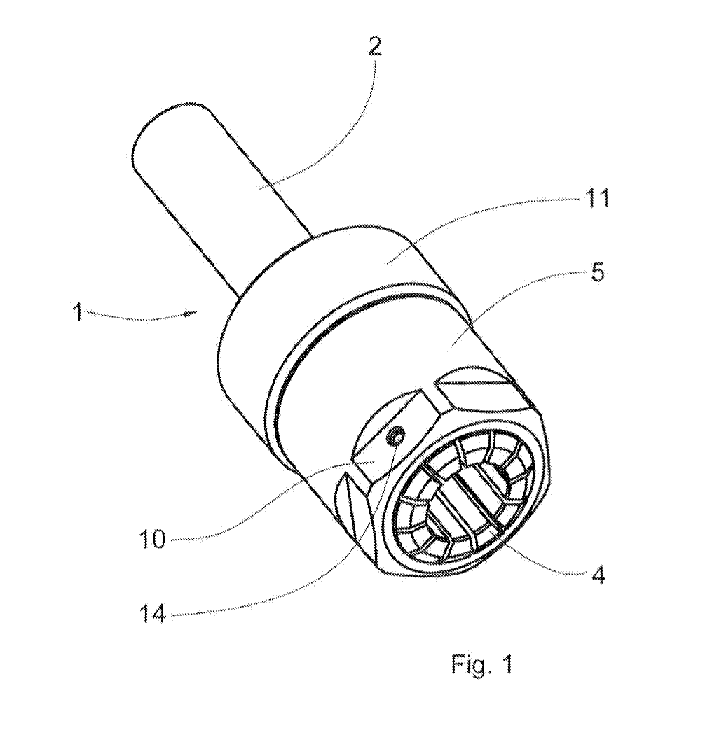

FIG. 1 is a perspective view of a first embodiment of the collet chuck according to the invention;

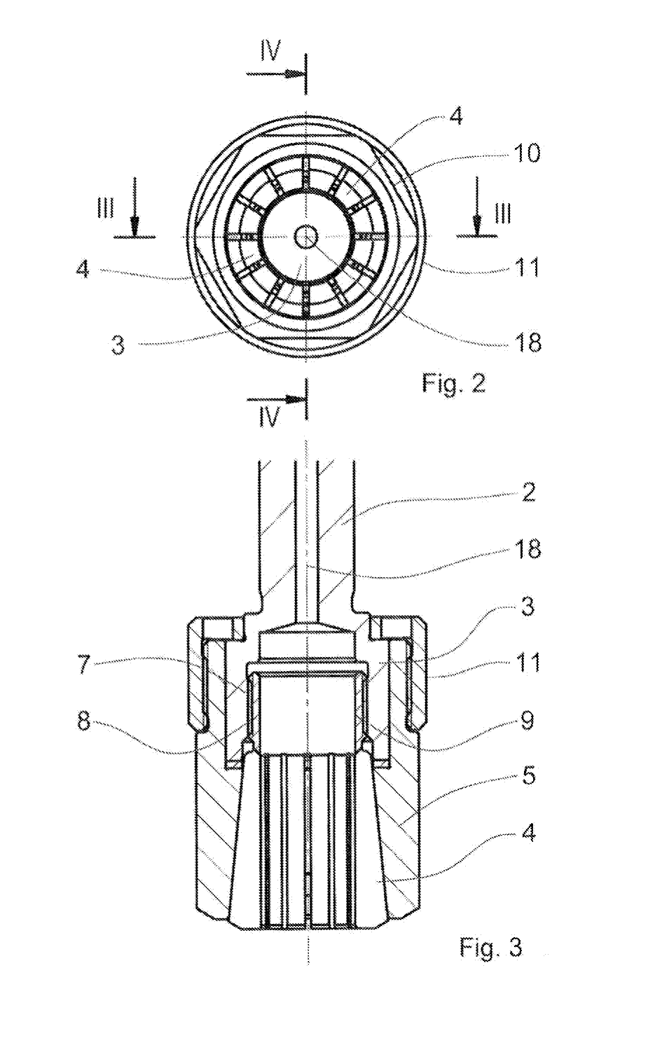

FIG. 2 is a top view of the collet chuck in FIG. 1;

FIG. 3 is section from FIG. 2;

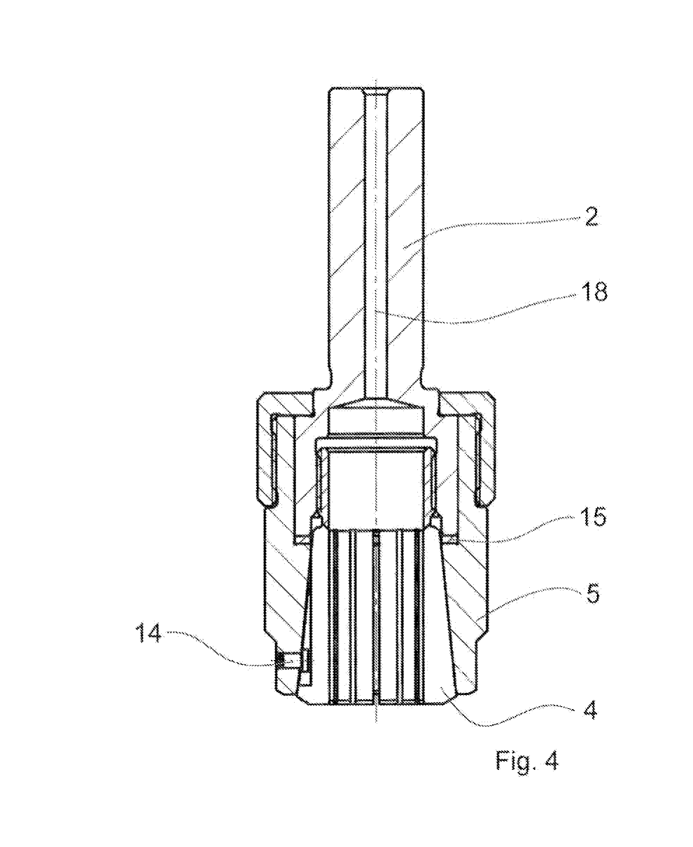

FIG. 4 is section IV-IV from FIG. 2;

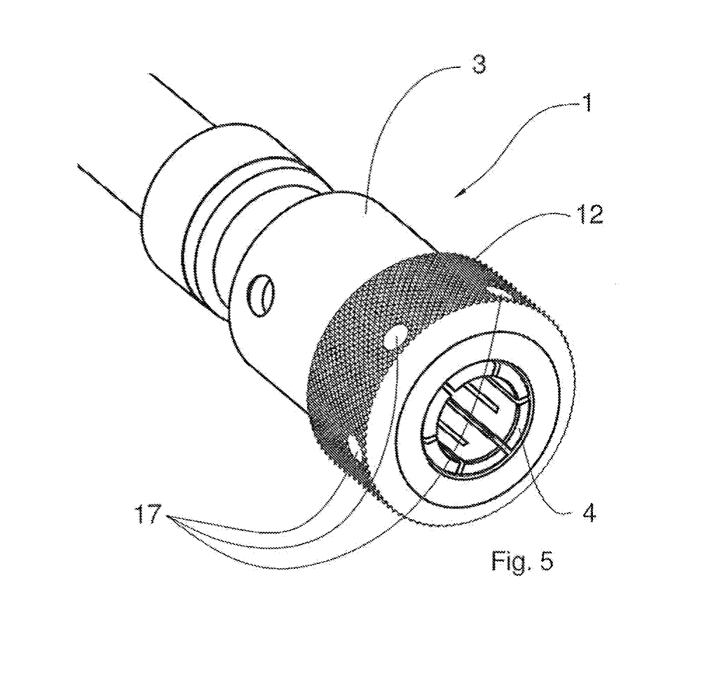

FIG. 5 is a perspective view of a second embodiment of the invention;

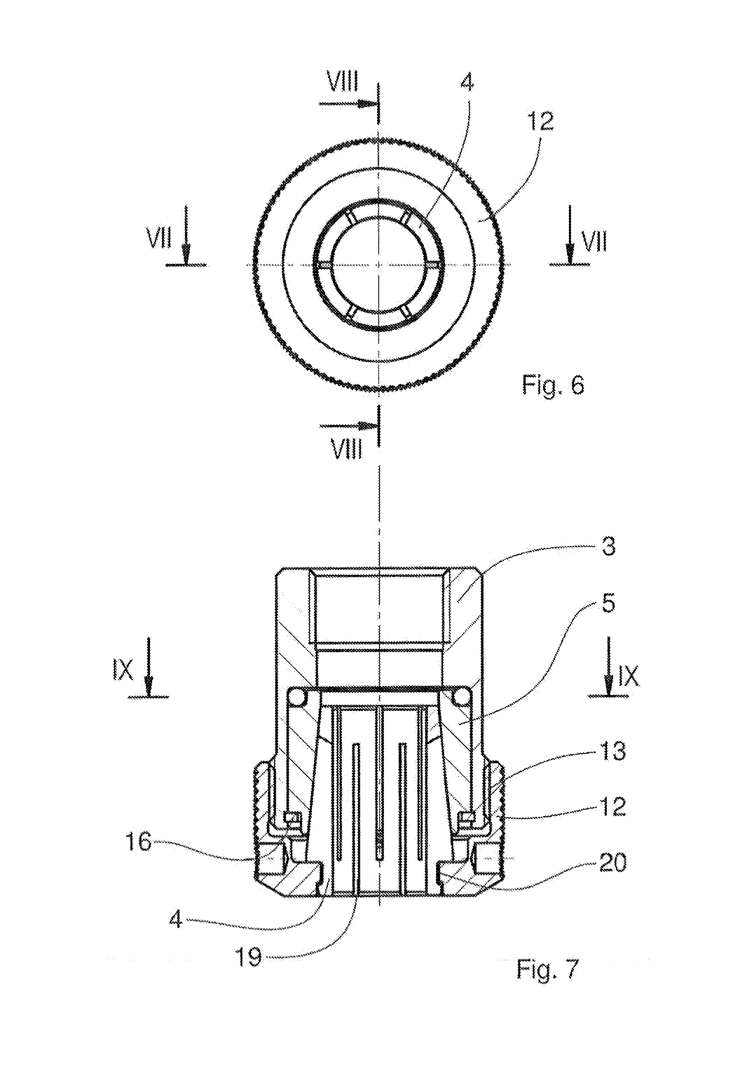

FIG. 6 is a top view of the embodiment in FIG. 5;

FIG. 7 is section VIII-VIII from FIG. 6;

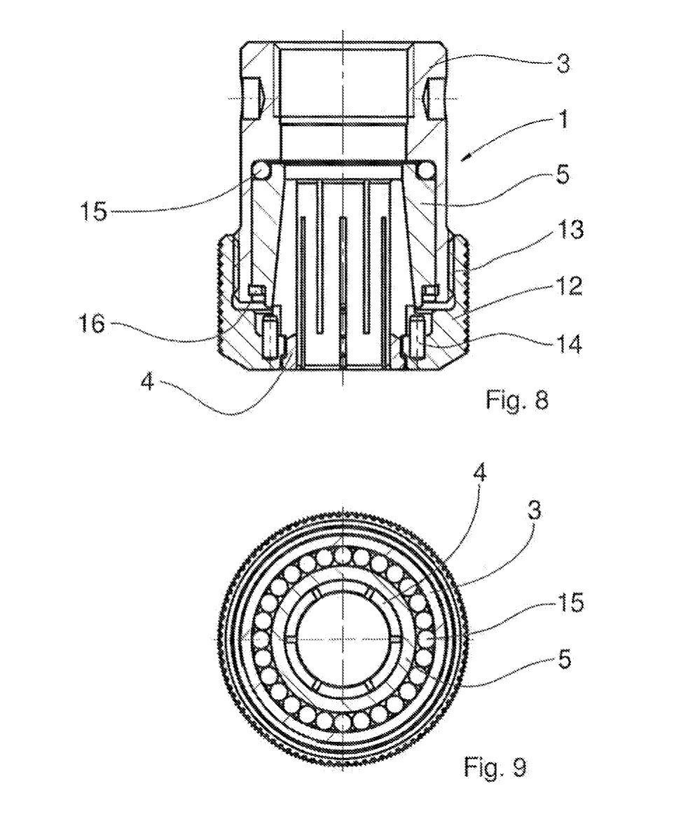

FIG. 8 is section VIII-VIII from FIG. 6,

FIG. 9 is cross section IX-IX from FIG. 7;

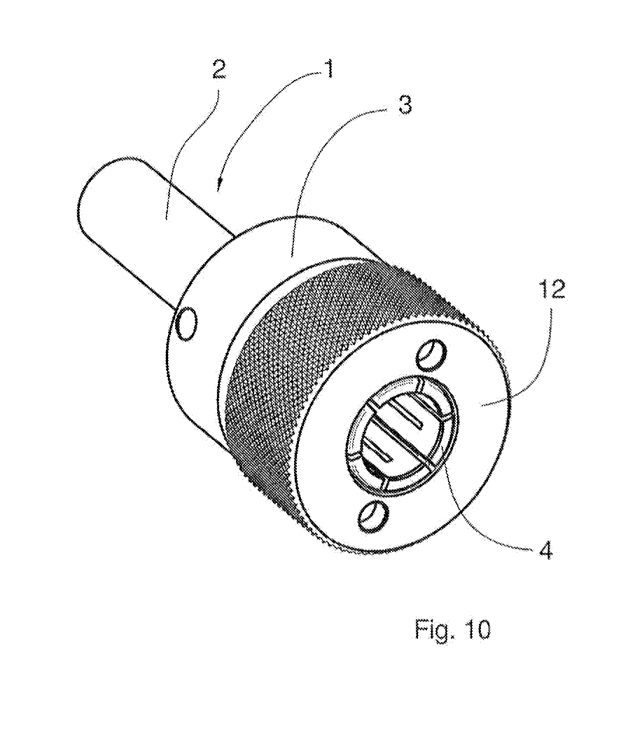

FIG. 10 is a perspective view of a further embodiment of the invention with a drive spindle that is integral with the chuck body;

FIG. 11 is a top view of the embodiment in FIG. 10;

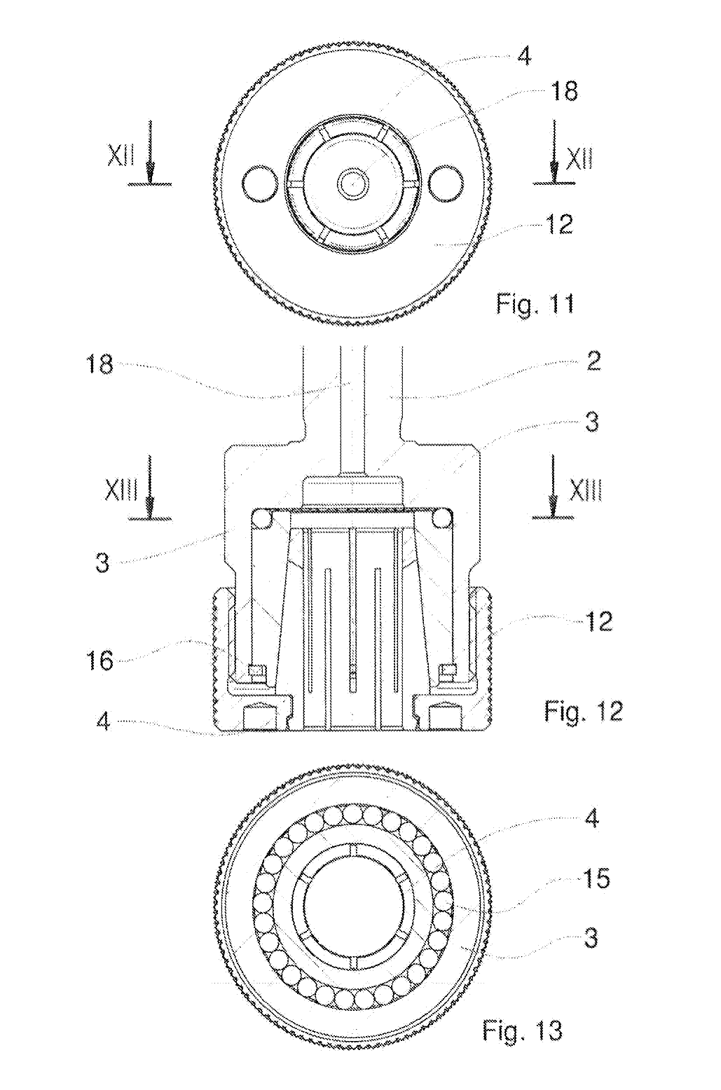

FIG. 12 is section XII-XII from FIG. 11;

FIG. 13 is cross section XIII-XIII from FIG. 12;

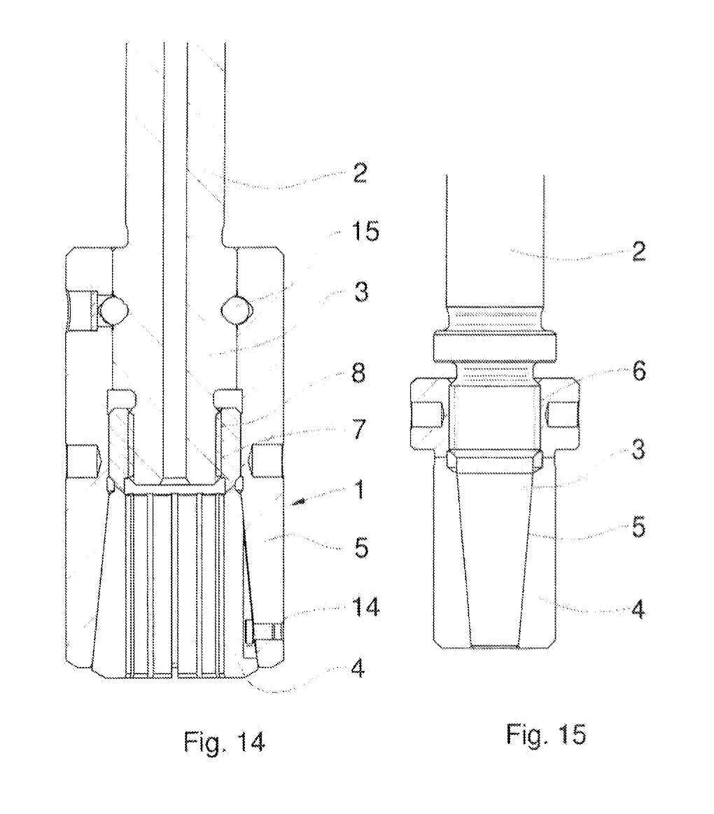

FIG. 14 is a longitudinal section through a further embodiment of the invention, and

FIG. 15 is a longitudinal section through a further embodiment of the invention with a collet that functions as an expanding mandrel.

In FIGS. 1 through 15, collet chucks 1 shown in the drawing have in common that they have a chuck body 3 that is connected or can be angularly fixed to a drive spindle 2, a collet 4 and a frustoconically tapered sleeve 5 carried by the chuck body 3. The tapered sleeve 5 is axially fixed on the chuck body 3. Further, between the body 3 and the collet 4 there is a threaded connection 6, so that when the shaft of a workpiece or tool is being clamped in, for example, a router, a basic gripping force is achieved by rotating the body 3. During operation of the collet chuck 1, braking moments act upon the tool that represent a moment of rotation, which is opposite to the direction of rotation of drive spindle 2, so that rotation of the collet 4 takes place with respect to the body 3 that, as a consequence of the threaded connection 6, results in axial displacement of the collet 4. This axial displacement of the collet 4 is converted into self-tightening due to abutment of the clamping segments of the collet 4 against the frustoconical surface of the sleeve 5, so that in the collet chucks 1 according to the invention, a self-tightening effect is realized in all embodiments.

In the embodiments shown in FIGS. 1 to 14, the sleeve 5 has a frustoconical inner surface and the collet 4 is surrounded by the sleeve 5, while FIG. 15 shows an embodiment in which the sleeve 5 is unitary with the body 3 and is surrounded by the collet 4. In the embodiment in FIG. 15, the sleeve 5 cannot rotate relative to the body 3, even though this is desirable and in fact the case in the other embodiments, because the sleeve 5 is rotationally fixed to the collet 4, namely in the embodiment according to FIGS. 1 through 4 by a clamping screw 14 extending radially through the sleeve 5 and acting upon the collet 4, which also is or can be used in the other embodiments.

As can be seen particularly in FIG. 4 with respect to the first embodiment, the body 3 is fitted with a threaded adapter 7 into which a thread 8 of a collar 9 of the collet 4 is screwed. FIG. 14, however, shows, in an alternate embodiment, that even the basically occurring kinematic reversal can be realized in which the external screwthread is on the body 3 and the collet 4 has the inner thread, i.e. the body 3 is screwed into a body adapter of the collet 4 with an external screwthread to form the threaded connection 6 between the body 3 and the collet 4.

As a result of the self-tightening effect, large clamping forces can be generated so that it is advantageous when at least one wrench flat 10 is formed on the sleeve 5 to make use of a wrench possible in the embodiment shown in FIG. 1.

The axially rear end of the sleeve 5 is specified in the embodiments shown in FIGS. 1 through 4 by using a locking element at the body 3, namely by a locking nut 11.

In FIGS. 5 to 13, two additional embodiments are shown that essentially differ in that, on the one hand, the drive spindle 2 can be detached from the chuck body, while in the other embodiment an integral construction is selected. In these illustrated embodiments, the collet 4 is rotationally and axially fixed to a clamping nut 12 that engages with a collet thread 13 formed on an outer surface of the body 3 for forming the threaded connection 6, the clamping nut 12 having a first sleeve section as carrier of a thread 8 of threaded connection 6 and a second sleeve section having a smaller diameter with a coupling ridge 20 formed on its inner surface and engaged in an annular groove of the collet 4. The surface of the nut 12 has a formation that increases friction, namely a flange. Further, formations on the nut 12, namely wrench flats 10 or bores 17 are provided for an auxiliary tool, these formations making it possible to transmit sufficiently high torque to the nut 12 to ensure safe opening of the collet chuck 1.

The drawings showing these two illustrated embodiments further indicate that the nut 12 is coupled with the collet 4 by two diametrically opposite pins 14 and the sleeve 5 is axially rearwardly braced against the chuck body via an axial-thrust bearing 15, while toward the front a snap ring 16 axially lock the parts together.

It must also be noted that between the clamping segments of the collet 4 are elastomeric ribs 19 at only the axial front sections of the clamping segments, which make sealing of the collet chuck 1 possible with improved alignment of the clamping segments relative to each other without disproportionately working against a secure clamping.

In all embodiments, a passage 18 for suction or blowing air or for axial tool ejection can be provided.

Reference numbers

| | |
|---|---|
| 1 | Collet chuck |
| 2 | Drive spindle |
| 3 | Chuck body |
| 4 | Collet |
| 5 | Tapered sleeve |
| 6 | Threaded connection |
| 7 | Threaded adapter |
| 8 | Thread |
| 9 | Collet collar |
| 10 | Wrench flat |
| 11 | Locking nut |
| 12 | Clamping nut |
| 13 | Collet thread |
| 14 | Pin/clamping bolt |
| 15 | Thrust bearing |
| 16 | Reinforcement ring |
| 17 | Bore |
| 18 | Passage |
| 19 | Elastomeric rib |
| 20 | Coupling ridge |

1. A collet chuck having a chuck body that is connected or can be rotationally fixed to the drive spindle, having a collet and a tapered sleeve that is carried on the chuck body, wherein the tapered sleeve is axially fixed on the chuck body and a threaded connection is operative between the chuck body and the collet.

2. The collet chuck according to claim 1, wherein the tapered sleeve surrounds the collet, has a frustoconical inner surface, and is rotatably mounted on the chuck body.

3. The collet chuck according to claim 2, wherein the tapered sleeve is rotationally fixed to the collet.

4. The collet chuck according to claim 1, wherein a threaded adapter is formed in the body into which a thread of a collar of the collet is screwed.

5. The collet chuck according to claim 1, wherein the body is screwed into a body adapter of the collet with an external screwthread.

6. The collet chuck according to claim 1, wherein the tapered sleeve is formed integral with the body and is surrounded by the collet.

7. The collet chuck according to claim 4, wherein the tapered sleeve has at least one formation that transmits torque, preferably a wrench flat.

8. The collet chuck according to claim 1, wherein the axially rear end of tapered sleeve is secured by a locking element to the body, preferably surrounded by a locking nut located at the body.

9. The collet chuck according to claim 1, wherein the collet is rotationally and axially fixed to a clamping nut that engages with a collet thread formed on an outer surface of the body for forming the threaded connection.

10. The collet chuck according to claim 9, wherein the clamping nut is coupled with the collet by at least one, preferably two, diametrically opposite pins.

11. The collet chuck according to claim 9, wherein the tapered sleeve is braced rearwardly by an axial-thrust bearing against the body or forwardly by a snap ring.

12. The collet chuck according to claim 9, wherein the clamping nut has formations, preferably wrench flats or bores, for an auxiliary tool.

13. The collet chuck according to claim 9, wherein the surface of the clamping nut has a formation that increases friction.

14. The collet chuck according to claim 9, wherein the clamping nut has a first sleeve section carrying the thread of the threaded connection and a second sleeve section having a smaller inner diameter with an inwardly projecting coupling ridge that engages with an annular groove of the collet.

15. The collet chuck according to claim 1, wherein between elastomeric ribs are provided the clamping segments of the collet, limited to the axial front sections of the clamping segments.

16. A collet chuck comprising:
a chuck body rotatable about an axis;
a collet axially shiftable relative to the chuck body and having a radially directed frustoconical surface centered on the axis and an oppositely radially directed cylindrical surface also centered on the axis;
a sleeve axially fixed on the chuck body and having a radially directed frustoconical surface bearing radially on the frustoconical surface of the collet; and
interengaging screwthreads between the body and the collet, whereby relative rotation of the collet and the body axially shifts the collet relative to the body and the sleeve.

17. The collet chuck defined in claim 16 wherein the sleeve surrounds the collet, one of the screwthreads is on the collet, and the other of the screwthreads is on the body.

18. The collet chuck defined in claim 17, further comprising:
structure rotationally coupling the collet to the sleeve.

19. The collet chuck defined in claim 16 wherein the body has a front end radially surrounding the sleeve, one of the screwthreads being an external screwthread on the body front end, the chuck further comprising:
a nut having an internal screwthread meshing with the external screwthread of the body front end and constituting the other of the screwthreads; and
structure rotationally coupling the collet to the nut.

20. The collet chuck defined in claim 16 wherein the sleeve is unitarily formed with the chuck body.
